(19) United States
(12) Patent Application Publication
(10) Pub. No.: US 2022/0405882 A1
(43) Pub. Date: Dec. 22, 2022

(54) CONVOLUTIONAL NEURAL NETWORK SUPER-RESOLUTION SYSTEM AND METHOD

(71) Applicant: GoPro, Inc., San Mateo, CA (US)

(72) Inventors: Matias Tassano Ferrés, Paris (FR); Charles Laroche, Paris (FR)

(21) Appl. No.: 17/845,723

(22) Filed: Jun. 21, 2022

Related U.S. Application Data
(60) Provisional application No. 63/213,555, filed on Jun. 22, 2021.

(51) Int. Cl. G06T 3/40; G06T 5/00

(52) U.S. Cl. CPC G06T 3/4046; G06T 5/002; G06T 5/003

(57) ABSTRACT

A non-blind generator or a blind generator can be used to generate a high-resolution image from a low-resolution image. The non-blind generator includes a kernel encoder, a concatenator, and a super-resolution network. The kernel encoder obtains a blur kernel to generate one or more kernel maps. The concatenator concatenates a low-resolution image to one or more kernel maps to obtain a concatenated image. The super-resolution network includes one or more convolutional layers that process the concatenated image. The super-resolution network includes a pixel shuffle layer that outputs a high-resolution image based on the processed concatenated image.

### CROSS REFERENCE TO RELATED APPLICATION(S)

This application claims priority to and the benefit of U.S. Provisional Patent Application No. 63/213,555, filed on Jun. 22, 2021, the contents of which are incorporated by reference herein in their entirety.

### TECHNICAL FIELD

This disclosure relates to image capture devices and systems.

### BACKGROUND

Recently, the single image super-resolution (SISR) field has been monopolized by learning-based methods, largely due to their effectiveness and performance. Many of these methods aim to recover a high-resolution (HR) image from a given low resolution (LR) input image by learning the mapping between LR/HR image pairs. Since creating an aligned LR/HR dataset is not trivial, models are typically trained with synthetic data. Most convolutional neural network (CNN)-based models assume that the LR images are bicubicly down-sampled from HR images. In addition, training images do not usually present other degradations, such as blur or noise. Thus, most SISR methods trained on synthetic data display poor performance on real-world images, as often the true degradation existent in LR images does not correspond to the assumptions above. To address these issues, a framework is needed that mimics real-world degradations to create realistic LR/HR pairs. The purpose of this framework would be to reduce the domain gap between the synthetized and real-world LR images. Additionally, it would be desirable to have a single convolutional super-resolution network that handles blurry and noisy data.

### SUMMARY

Disclosed herein are implementations of super-resolution systems and methods. An aspect may include a non-blind generator that can be used to generate a high-resolution image from a low-resolution image. The non-blind generator may include a kernel encoder, a concatenator, a super-resolution network, or any combination thereof. The kernel encoder may be configured to obtain a blur kernel to generate one or more kernel maps. The concatenator may be configured to concatenate a low-resolution image to one or more kernel maps to obtain a concatenated image. The super-resolution network may include one or more convolutional layers that are configured to process the concatenated image. The super-resolution network may include a pixel shuffle layer that is configured to output a high-resolution image based on the processed concatenated image.

An aspect may include a method for SISR. The method may include obtaining a kernel. The method may include generating one or more kernel maps. The one or more kernel maps may be based on one or more kernels, for example, the obtained kernel. The one or more kernel maps may include spatially variant kernel degradations. The method may include obtaining a concatenated image. The concatenated image may be based on a low-resolution image and the one or more kernel maps. The method may include processing the concatenated image using one or more convolutional layers of a super-resolution network to obtain a processed concatenated image. The method may include outputting a high-resolution image. The high-resolution image may be based on the processed concatenated image.

An aspect may include an image capture device. The image capture device may include an image sensor. The image sensor may be configured to obtain a low-resolution image. The image capture device may include a kernel encoder. The kernel encoder may be configured to obtain a kernel. The kernel encoder may be configured to generate a kernel map. The image capture device may include a processor. The processor may be configured to scale the low-resolution image to obtain a scaled image. The image capture device may include a concatenator. The concatenator may be configured to concatenate the low-resolution image to the kernel map to obtain a concatenated image. The image capture device may include a super-resolution network. The super-resolution network may be configured to obtain the concatenated image from the concatenator. The super-resolution network may include one or more convolutional layers configured to process the concatenated image. The super-resolution network may include a pixel shuffle layer configured to output a high-resolution image based on the processed concatenated image.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-B are isometric views of an example of an image capture device.

FIGS. 2A-B are isometric views of another example of an image capture device.

FIG. 2C is a top view of the image capture device of FIGS. 2A-B.

FIG. 2D is a partial cross-sectional view of the image capture device of FIG. 2C.

FIG. 3 is a block diagram of electronic components of an image capture device.

FIG. 4 is a block diagram of an example of a data generation pipeline in accordance with embodiments of this disclosure.

FIG. 5 is a block diagram of an example of a noiseflow block in accordance with embodiments of this disclosure.

FIG. 6 is a block diagram of an example of a non-blind generator architecture in accordance with embodiments of this disclosure.

FIG. 7 is a block diagram of an example of a kernel prediction for a blind model in accordance with embodiments of this disclosure.

FIG. 8 is a flow diagram of an example of a method for single image super-resolution (SISR) in accordance with embodiments of this disclosure.

### DETAILED DESCRIPTION

SISR systems and methods aim to up-sample a low-resolution (LR) image to a high resolution (HR) image. In other words, a goal of SISR may be to multiply the size of an image by a given scale factor. The problem is ill-posed since many solutions exist for a single LR pixel. To reduce the size of the search space, a prior is usually set on the HR images, where the prior refers to prior information. The prior information may be defined as the probability assigned to a parameter in advance of any empirical evidence. For example, the prior information may be a distribution in which it is assumed the HR images will follow. That can be done by learning a mapping between LR and HR pairs of images. A classical approach is to train a CNN to learn such a mapping. One example method to train them may use the mean squared error (MSE) loss. However, using Generative Adversarial Networks (GAN) based loss to train those models may yield better visual results with more texture. One main challenge in super-resolution is the robustness to noise and blur. Neural networks trained on GAN based loss tend to create artifacts when the LR inputs are blurry or noisy.

Blurry and noisy inputs are frequent in real-life applications, which is why creating a model that can handle this kind of input is necessary if it needs to be implemented in real-world cameras. Super-resolution for multiple degradations may be used to address this issue. The idea behind super-resolution for multiple degradations is to create a model that takes a LR, blurry and noisy input and returns a deblurred and denoised HR version of this input. To perform this operation, typical approaches use a CNN that takes as input the low-resolution image, the blur kernel, and the noise level. Those models are referred as non-blind models since information on the blur kernel and noise are input. However, these models tend to over-smooth the details in the images. In addition, many super-resolution models that handle multiple degradations only work with Gaussian degradations. Real world degradations are more complex than the Gaussian noise and blur and results in models that have poor performance on real world images.

One or more embodiments disclosed herein may utilize blind models. A common method to up-sample images in computer vision is to use a kernel-based method. The main idea is to expand the size of the image by adding lines and columns of zeros between the pixels of the LR image. The LR image is convolved with a filter, such as a Gaussian filter or a bicubic filter. The resulting image may be multiplied by a factor equal to s², where s is the scale factor. These example methods are fast and robust, however they lose information. Neural networks may be used for the task of up-sampling. A super-resolution CNN (SRCNN) is an example model that uses a CNN for the task of super-resolution. In this example, the super-resolution problem is set as an optimization problem that learns the mapping between a LR image and its HR version. The mapping may be modelled using a deep CNN. This example may optimize the network using the MSE loss. Other example methods may use this approach and change the CNN architectures or losses. These models may have acceptable reconstruction properties, however they may have difficulty recovering the high-frequency details.

In some examples, enhanced super-resolution GAN (ESRGAN) may use a GAN based loss to reconstruct high-frequency details. In these examples, a combination of pixel-wise L1 loss may be used, and visual geometry group (VGG)-19 features based L1 loss and an adversarial loss may be used to optimize the neural network. These examples also provide a state-of-the-art neural network architecture for super-resolution based on Residual in Residual Dense Block. ESRGAN provides state-of-the-art results in super-resolution. However, ESRGAN struggles to generalize on real images. These examples build an LR/HR paired dataset using bicubic down-sampling. The use case for super-resolution models is to zoom a crop in an image, however those crops are not bicubic down-samplings of a larger image, therefore the models are biased. A real-world super-resolution (RealSR) example may use an ESRGAN model with a different approach to generate the LR/HR pairs. In this example, instead of down-sampling the images with bicubic, the model learns realistic down-sampling kernels with KernelGAN. The model also generates a realistic noise level set by computing the noise level on smooth patches. Finally, the model uses realistic down-sampling kernels and noise level to create the LR/HR pairs and train ESRGAN on those generated pairs.

One or more embodiments disclosed herein may utilize non-blind models. Super-resolution methods suppose that the blur and noise will be handled by the network without giving the network any information. In non-blind methods, information associated with the noise and kernel are input to the network. A super-resolution network for multiple degradations (SRMD) may be based on a super-resolution model that is robust to noise and blur. The SRMD model may take the low-resolution image, a noise map corresponding to the noise level of every pixel, and a vector that will be the principal component analysis (PCA) of the blur kernel as input. The SRMD model may be trained on MSE for different noise levels and blur kernels. Both noise and kernels may be Gaussian in SRMD. For the network architecture, a CNN architecture may be used with a pixel shuffle layer at the end to perform the up sampling. With SRMD methods, consistent super-resolution results may be achieved even in the case of blurry and noisy images. However, in practical cases, it is difficult to obtain the true value of the noise level and kernel. For example, when the estimated blur kernel is biased, the super-resolution may not be accurate and may introduce artifacts. To solve this issue, an iterative method may be used to estimate the blur kernel in the image. In this example, the SRMD model may determine a first prediction of the kernel, perform the super-resolution, and then correct the prediction of the kernel using the previous prediction and the up-sampled image and so on until the kernel prediction has converged. The kernel and noise prediction may be used to feed SRMD model. With this method, a blind model that is robust to blur and noise may be obtained.

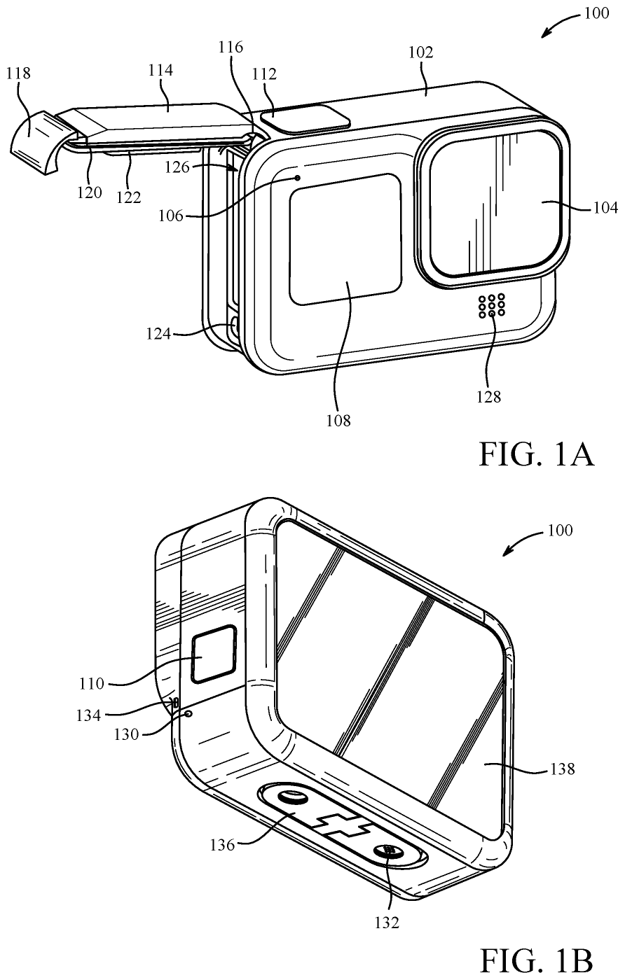

FIGS. 1A-B are isometric views of an example of an image capture device 100. The image capture device 100 may include a body 102, a lens 104 structured on a front surface of the body 102, various indicators on the front surface of the body 102 (such as light-emitting diodes (LEDs), displays, and the like), various input mechanisms (such as buttons, switches, and/or touch-screens), and electronics (such as imaging electronics, power electronics, etc.) internal to the body 102 for capturing images via the lens 104 and/or performing other functions. The lens 104 is configured to receive light incident upon the lens 104 and to direct received light onto an image sensor internal to the body 102. The image capture device 100 may be configured to capture images and video and to store captured images and video for subsequent display or playback.

The image capture device 100 may include an LED or another form of indicator 106 to indicate a status of the image capture device 100 and a liquid-crystal display (LCD) or other form of a display 108 to show status information such as battery life, camera mode, elapsed time, and the like. The image capture device 100 may also include a mode button 110 and a shutter button 112 that are configured to allow a user of the image capture device 100 to interact with the image capture device 100. For example, the mode button 110 and the shutter button 112 may be used to turn the image capture device 100 on and off, scroll through modes and settings, and select modes and change settings. The image capture device 100 may include additional buttons or interfaces (not shown) to support and/or control additional functionality.

The image capture device 100 may include a door 114 coupled to the body 102, for example, using a hinge mechanism 116. The door 114 may be secured to the body 102 using a latch mechanism 118 that releasably engages the body 102 at a position generally opposite the hinge mechanism 116. The door 114 may also include a seal 120 and a battery interface 122. When the door 114 is an open position, access is provided to an input-output (I/O) interface 124 for connecting to or communicating with external devices as described below and to a battery receptacle 126 for placement and replacement of a battery (not shown). The battery receptacle 126 includes operative connections (not shown) for power transfer between the battery and the image capture device 100. When the door 114 is in a closed position, the seal 120 engages a flange (not shown) or other interface to provide an environmental seal, and the battery interface 122 engages the battery to secure the battery in the battery receptacle 126. The door 114 can also have a removed position (not shown) where the entire door 114 is separated from the image capture device 100, that is, where both the hinge mechanism 116 and the latch mechanism 118 are decoupled from the body 102 to allow the door 114 to be removed from the image capture device 100.

The image capture device 100 may include a microphone 128 on a front surface and another microphone 130 on a side surface. The image capture device 100 may include other microphones on other surfaces (not shown). The microphones 128, 130 may be configured to receive and record audio signals in conjunction with recording video or separate from recording of video. The image capture device 100 may include a speaker 132 on a bottom surface of the image capture device 100. The image capture device 100 may include other speakers on other surfaces (not shown). The speaker 132 may be configured to play back recorded audio or emit sounds associated with notifications.

A front surface of the image capture device 100 may include a drainage channel 134. A bottom surface of the image capture device 100 may include an interconnect mechanism 136 for connecting the image capture device 100 to a handle grip or other securing device. In the example shown in FIG. 1B, the interconnect mechanism 136 includes folding protrusions configured to move between a nested or collapsed position as shown and an extended or open position (not shown) that facilitates coupling of the protrusions to mating protrusions of other devices such as handle grips, mounts, clips, or like devices.

The image capture device 100 may include an interactive display 138 that allows for interaction with the image capture device 100 while simultaneously displaying information on a surface of the image capture device 100.

The image capture device 100 of FIGS. 1A-B includes an exterior that encompasses and protects internal electronics. In the present example, the exterior includes six surfaces (i.e. a front face, a left face, a right face, a back face, a top face, and a bottom face) that form a rectangular cuboid. Furthermore, both the front and rear surfaces of the image capture device 100 are rectangular. In other embodiments, the exterior may have a different shape. The image capture device 100 may be made of a rigid material such as plastic, aluminum, steel, or fiberglass. The image capture device 100 may include features other than those described here. For example, the image capture device 100 may include additional buttons or different interface features, such as interchangeable lenses, cold shoes, and hot shoes that can add functional features to the image capture device 100.

The image capture device 100 may include various types of image sensors, such as charge-coupled device (CCD) sensors, active pixel sensors (APS), complementary metal-oxide-semiconductor (CMOS) sensors, N-type metal-oxide-semiconductor (NMOS) sensors, and/or any other image sensor or combination of image sensors.

Although not illustrated, in various embodiments, the image capture device 100 may include other additional electrical components (e.g., an image processor, camera system-on-chip (SoC), etc.), which may be included on one or more circuit boards within the body 102 of the image capture device 100.

The image capture device 100 may interface with or communicate with an external device, such as an external user interface device (not shown), via a wired or wireless computing communication link (e.g., the I/O interface 124). Any number of computing communication links may be used. The computing communication link may be a direct computing communication link or an indirect computing communication link, such as a link including another device or a network, such as the internet, may be used.

In some implementations, the computing communication link may be a Wi-Fi link, an infrared link, a Bluetooth (BT) link, a cellular link, a ZigBee link, a near field communications (NFC) link, such as an ISO/IEC 20643 protocol link, an Advanced Network Technology interoperability (ANT+) link, and/or any other wireless communications link or combination of links.

In some implementations, the computing communication link may be an HDMI link, a USB link, a digital video interface link, a display port interface link, such as a Video Electronics Standards Association (VESA) digital display interface link, an Ethernet link, a Thunderbolt link, and/or other wired computing communication link.

The image capture device 100 may transmit images, such as panoramic images, or portions thereof, to the external user interface device via the computing communication link, and the external user interface device may store, process, display, or a combination thereof the panoramic images.

The external user interface device may be a computing device, such as a smartphone, a tablet computer, a phablet, a smart watch, a portable computer, personal computing device, and/or another device or combination of devices configured to receive user input, communicate information with the image capture device 100 via the computing communication link, or receive user input and communicate information with the image capture device 100 via the computing communication link.

The external user interface device may display, or otherwise present, content, such as images or video, acquired by the image capture device 100. For example, a display of the external user interface device may be a viewport into the three-dimensional space represented by the panoramic images or video captured or created by the image capture device 100.

The external user interface device may communicate information, such as metadata, to the image capture device 100. For example, the external user interface device may send orientation information of the external user interface device with respect to a defined coordinate system to the image capture device 100, such that the image capture device 100 may determine an orientation of the external user interface device relative to the image capture device 100.

Based on the determined orientation, the image capture device 100 may identify a portion of the panoramic images or video captured by the image capture device 100 for the image capture device 100 to send to the external user interface device for presentation as the viewport. In some implementations, based on the determined orientation, the image capture device 100 may determine the location of the external user interface device and/or the dimensions for viewing of a portion of the panoramic images or video.

The external user interface device may implement or execute one or more applications to manage or control the image capture device 100. For example, the external user interface device may include an application for controlling camera configuration, video acquisition, video display, or any other configurable or controllable aspect of the image capture device 100.

The user interface device, such as via an application, may generate and share, such as via a cloud-based or social media service, one or more images, or short video clips, such as in response to user input. In some implementations, the external user interface device, such as via an application, may remotely control the image capture device 100 such as in response to user input.

The external user interface device, such as via an application, may display unprocessed or minimally processed images or video captured by the image capture device 100 contemporaneously with capturing the images or video by the image capture device 100, such as for shot framing or live preview, and which may be performed in response to user input. In some implementations, the external user interface device, such as via an application, may mark one or more key moments contemporaneously with capturing the images or video by the image capture device 100, such as with a tag or highlight in response to a user input or user gesture.

The external user interface device, such as via an application, may display or otherwise present marks or tags associated with images or video, such as in response to user input. For example, marks may be presented in a camera roll application for location review and/or playback of video highlights.

The external user interface device, such as via an application, may wirelessly control camera software, hardware, or both. For example, the external user interface device may include a web-based graphical interface accessible by a user for selecting a live or previously recorded video stream from the image capture device 100 for display on the external user interface device.

The external user interface device may receive information indicating a user setting, such as an image resolution setting (e.g., 3840 pixels by 2160 pixels), a frame rate setting (e.g., 60 frames per second (fps)), a location setting, and/or a context setting, which may indicate an activity, such as mountain biking, in response to user input, and may communicate the settings, or related information, to the image capture device 100.

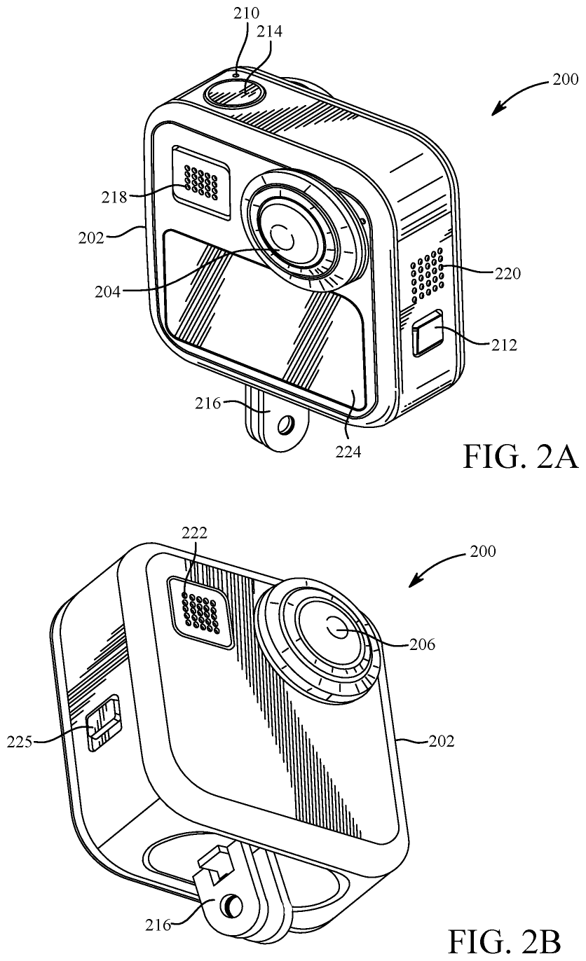

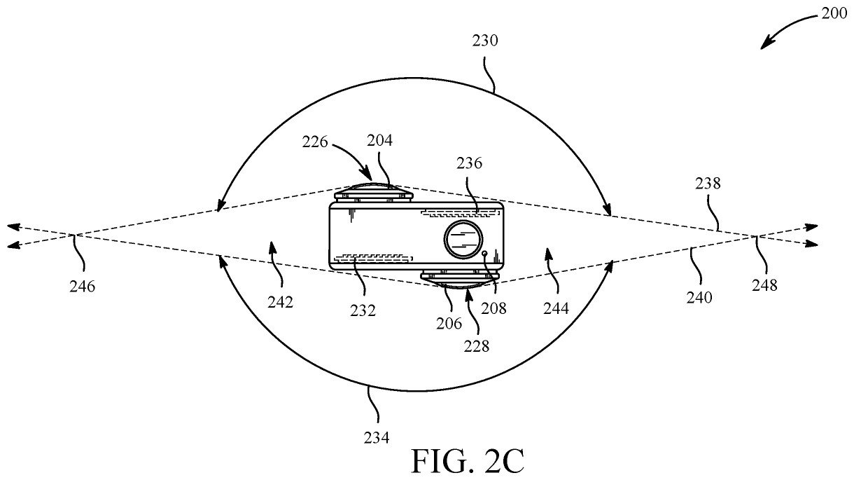

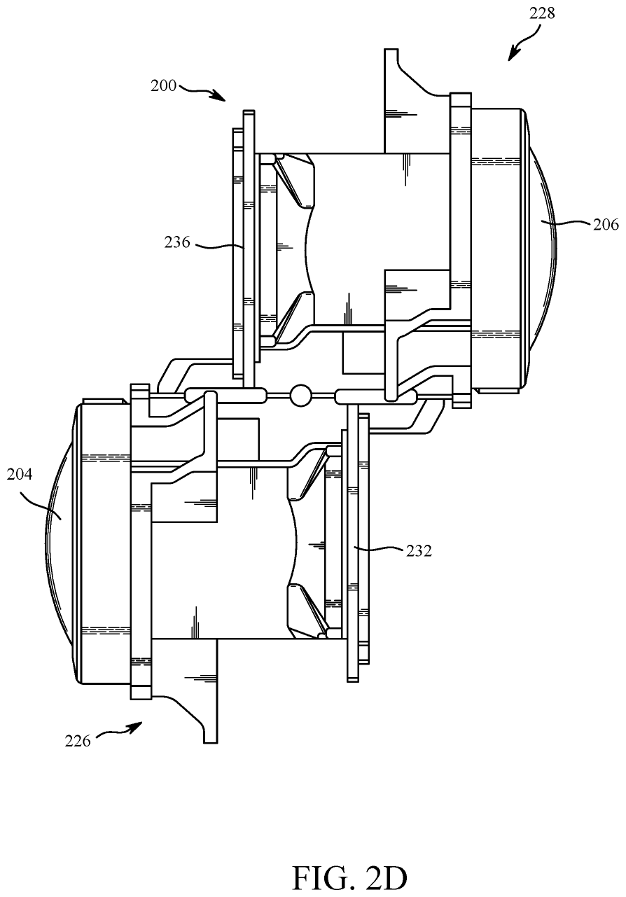

FIGS. 2A-B illustrate another example of an image capture device 200. The image capture device 200 includes a body 202 and two camera lenses 204 and 206 disposed on opposing surfaces of the body 202, for example, in a back-to-back configuration, Janus configuration, or offset Janus configuration. The body 202 of the image capture device 200 may be made of a rigid material such as plastic, aluminum, steel, or fiberglass.

The image capture device 200 includes various indicators on the front of the surface of the body 202 (such as LEDs, displays, and the like), various input mechanisms (such as buttons, switches, and touch-screen mechanisms), and electronics (e.g., imaging electronics, power electronics, etc.) internal to the body 202 that are configured to support image capture via the two camera lenses 204 and 206 and/or perform other imaging functions.

The image capture device 200 includes various indicators, for example, LEDs 208, 210 to indicate a status of the image capture device 100. The image capture device 200 may include a mode button 212 and a shutter button 214 configured to allow a user of the image capture device 200 to interact with the image capture device 200, to turn the image capture device 200 on, and to otherwise configure the operating mode of the image capture device 200. It should be appreciated, however, that, in alternate embodiments, the image capture device 200 may include additional buttons or inputs to support and/or control additional functionality.

The image capture device 200 may include an interconnect mechanism 216 for connecting the image capture device 200 to a handle grip or other securing device. In the example shown in FIGS. 2A and 2B, the interconnect mechanism 216 includes folding protrusions configured to move between a nested or collapsed position (not shown) and an extended or open position as shown that facilitates coupling of the protrusions to mating protrusions of other devices such as handle grips, mounts, clips, or like devices.

The image capture device 200 may include audio components 218, 220, 222 such as microphones configured to receive and record audio signals (e.g., voice or other audio commands) in conjunction with recording video. The audio component 218, 220, 222 can also be configured to play back audio signals or provide notifications or alerts, for example, using speakers. Placement of the audio components 218, 220, 222 may be on one or more of several surfaces of the image capture device 200. In the example of FIGS. 2A and 2B, the image capture device 200 includes three audio components 218, 220, 222, with the audio component 218 on a front surface, the audio component 220 on a side surface, and the audio component 222 on a back surface of the image capture device 200. Other numbers and configurations for the audio components are also possible.

The image capture device 200 may include an interactive display 224 that allows for interaction with the image capture device 200 while simultaneously displaying information on a surface of the image capture device 200. The interactive display 224 may include an I/O interface, receive touch inputs, display image information during video capture, and/or provide status information to a user. The status information provided by the interactive display 224 may include battery power level, memory card capacity, time elapsed for a recorded video, etc.

The image capture device 200 may include a release mechanism 225 that receives a user input to in order to change a position of a door (not shown) of the image capture device 200. The release mechanism 225 may be used to open the door (not shown) in order to access a battery, a battery receptacle, an I/O interface, a memory card interface, etc. (not shown) that are similar to components described in respect to the image capture device 100 of FIGS. 1A and 1B.

In some embodiments, the image capture device 200 described herein includes features other than those described. For example, instead of the I/O interface and the interactive display 224, the image capture device 200 may include additional interfaces or different interface features. For example, the image capture device 200 may include additional buttons or different interface features, such as interchangeable lenses, cold shoes, and hot shoes that can add functional features to the image capture device 200.

FIG. 2C is a top view of the image capture device 200 of FIGS. 2A-B and FIG. 2D is a partial cross-sectional view of the image capture device 200 of FIG. 2C. The image capture device 200 is configured to capture spherical images, and accordingly, includes a first image capture device 226 and a second image capture device 228. The first image capture device 226 defines a first field-of-view 230 and includes the lens 204 that receives and directs light onto a first image sensor 232. Similarly, the second image capture device 228 defines a second field-of-view 234 and includes the lens 206 that receives and directs light onto a second image sensor 236. To facilitate the capture of spherical images, the image capture devices 226 and 228 (and related components) may be arranged in a back-to-back (Janus) configuration such that the lenses 204, 206 face in generally opposite directions.

The fields-of-view 230, 234 of the lenses 204, 206 are shown above and below boundaries 238, 240 indicated in dotted line. Behind the first lens 204, the first image sensor 232 may capture a first hyper-hemispherical image plane from light entering the first lens 204, and behind the second lens 206, the second image sensor 236 may capture a second hyper-hemispherical image plane from light entering the second lens 206.

One or more areas, such as blind spots 242, 244 may be outside of the fields-of-view 230, 234 of the lenses 204, 206 so as to define a “dead zone.” In the dead zone, light may be obscured from the lenses 204, 206 and the corresponding image sensors 232, 236, and content in the blind spots 242, 244 may be omitted from capture. In some implementations, the image capture devices 226, 228 may be configured to minimize the blind spots 242, 244.

The fields-of-view 230, 234 may overlap. Stitch points 246, 248 proximal to the image capture device 200, that is, locations at which the fields-of-view 230, 234 overlap, may be referred to herein as overlap points or stitch points. Content captured by the respective lenses 204, 206 that is distal to the stitch points 246, 248 may overlap.

Images contemporaneously captured by the respective image sensors 232, 236 may be combined to form a combined image. Generating a combined image may include correlating the overlapping regions captured by the respective image sensors 232, 236, aligning the captured fields-of-view 230, 234, and stitching the images together to form a cohesive combined image.

A slight change in the alignment, such as position and/or tilt, of the lenses 204, 206, the image sensors 232, 236, or both, may change the relative positions of their respective fields-of-view 230, 234 and the locations of the stitch points 246, 248. A change in alignment may affect the size of the blind spots 242, 244, which may include changing the size of the blind spots 242, 244 unequally.

Incomplete or inaccurate information indicating the alignment of the image capture devices 226, 228, such as the locations of the stitch points 246, 248, may decrease the accuracy, efficiency, or both of generating a combined image. In some implementations, the image capture device 200 may maintain information indicating the location and orientation of the lenses 204, 206 and the image sensors 232, 236 such that the fields-of-view 230, 234, the stitch points 246, 248, or both may be accurately determined; the maintained information may improve the accuracy, efficiency, or both of generating a combined image.

The lenses 204, 206 may be laterally offset from each other, may be off-center from a central axis of the image capture device 200, or may be laterally offset and off-center from the central axis. As compared to image capture devices with back-to-back lenses, such as lenses aligned along the same axis, image capture devices including laterally offset lenses may include substantially reduced thickness relative to the lengths of the lens barrels securing the lenses. For example, the overall thickness of the image capture device 200 may be close to the length of a single lens barrel as opposed to twice the length of a single lens barrel as in a back-to-back lens configuration. Reducing the lateral distance between the lenses 204, 206 may improve the overlap in the fields-of-view 230, 234. In another embodiment (not shown), the lenses 204, 206 may be aligned along a common imaging axis.

Images or frames captured by the image capture devices 226, 228 may be combined, merged, or stitched together to produce a combined image, such as a spherical or panoramic image, which may be an equirectangular planar image. In some implementations, generating a combined image may include use of techniques including noise reduction, tone mapping, white balancing, or other image correction. In some implementations, pixels along the stitch boundary may be matched accurately to minimize boundary discontinuities.

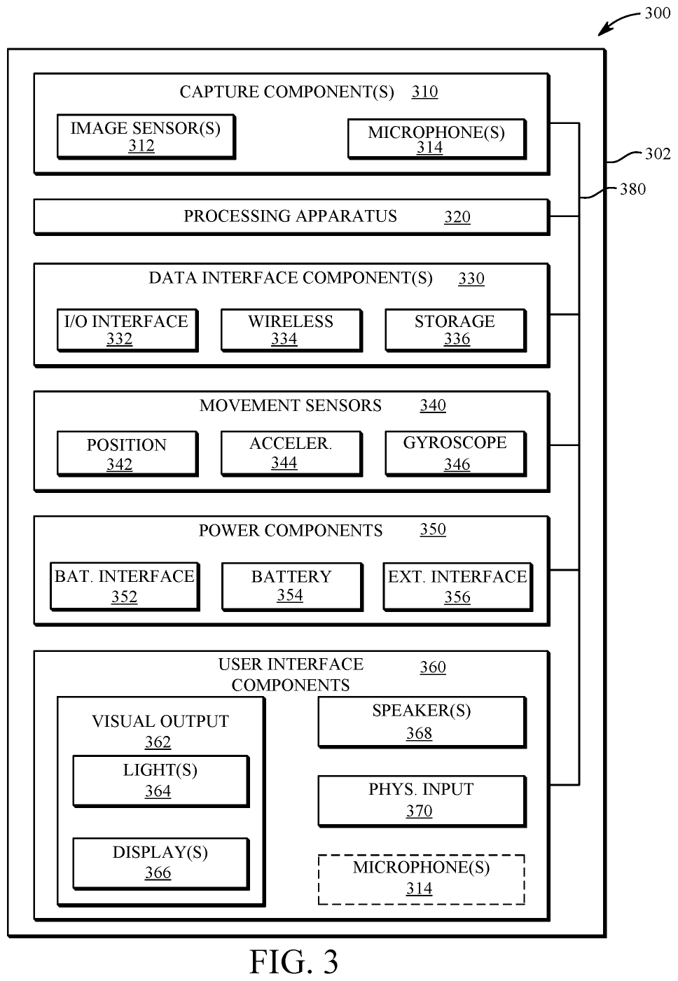

FIG. 3 is a block diagram of electronic components in an image capture device 300. The image capture device 300 may be a single-lens image capture device, a multi-lens image capture device, or variations thereof, including an image capture device with multiple capabilities such as use of interchangeable integrated sensor lens assemblies. The description of the image capture device 300 is also applicable to the image capture devices 100, 200 of FIGS. 1A-B and 2A-D.

The image capture device 300 includes a body 302 which includes electronic components such as capture components 310, a processing apparatus 320, data interface components 330, movement sensors 340, power components 350, and/or user interface components 360.

The capture components 310 include one or more image sensors 312 for capturing images and one or more microphones 314 for capturing audio.

The image sensor(s) 312 is configured to detect light of a certain spectrum (e.g., the visible spectrum or the infrared spectrum) and convey information constituting an image as electrical signals (e.g., analog or digital signals). The image sensor(s) 312 detects light incident through a lens coupled or connected to the body 302. The image sensor(s) 312 may be any suitable type of image sensor, such as a charge-coupled device (CCD) sensor, active pixel sensor (APS), complementary metal-oxide-semiconductor (CMOS) sensor, N-type metal-oxide-semiconductor (NMOS) sensor, and/or any other image sensor or combination of image sensors. Image signals from the image sensor(s) 312 may be passed to other electronic components of the image capture device 300 via a bus 380, such as to the processing apparatus 320. In some implementations, the image sensor(s) 312 includes a digital-to-analog converter. A multi-lens variation of the image capture device 300 can include multiple image sensors 312.

The microphone(s) 314 is configured to detect sound, which may be recorded in conjunction with capturing images to form a video. The microphone(s) 314 may also detect sound in order to receive audible commands to control the image capture device 300.

The processing apparatus 320 may be configured to perform image signal processing (e.g., filtering, tone mapping, stitching, and/or encoding) to generate output images based on image data from the image sensor(s) 312. The processing apparatus 320 may include one or more processors having single or multiple processing cores. In some implementations, the processing apparatus 320 may include an application specific integrated circuit (ASIC). For example, the processing apparatus 320 may include a custom image signal processor. The processing apparatus 320 may exchange data (e.g., image data) with other components of the image capture device 300, such as the image sensor(s) 312, via the bus 380.

The processing apparatus 320 may include memory, such as a random-access memory (RAM) device, flash memory, or another suitable type of storage device, such as a non-transitory computer-readable memory. The memory of the processing apparatus 320 may include executable instructions and data that can be accessed by one or more processors of the processing apparatus 320. For example, the processing apparatus 320 may include one or more dynamic random-access memory (DRAM) modules, such as double data rate synchronous dynamic random-access memory (DDR SDRAM). In some implementations, the processing apparatus 320 may include a digital signal processor (DSP). More than one processing apparatus may also be present or associated with the image capture device 300.

The data interface components 330 enable communication between the image capture device 300 and other electronic devices, such as a remote control, a smartphone, a tablet computer, a laptop computer, a desktop computer, or a storage device. For example, the data interface components 330 may be used to receive commands to operate the image capture device 300, transfer image data to other electronic devices, and/or transfer other signals or information to and from the image capture device 300. The data interface components 330 may be configured for wired and/or wireless communication. For example, the data interface components 330 may include an I/O interface 332 that provides wired communication for the image capture device, which may be a USB interface (e.g., USB type-C), a high-definition multimedia interface (HDMI), or a FireWire interface. The data interface components 330 may include a wireless data interface 334 that provides wireless communication for the image capture device 300, such as a Bluetooth interface, a ZigBee interface, and/or a Wi-Fi interface. The data interface components 330 may include a storage interface 336, such as a memory card slot configured to receive and operatively couple to a storage device (e.g., a memory card) for data transfer with the image capture device 300 (e.g., for storing captured images and/or recorded audio and video).

The movement sensors 340 may detect the position and movement of the image capture device 300. The movement sensors 340 may include a position sensor 342, an accelerometer 344, or a gyroscope 346. The position sensor 342, such as a global positioning system (GPS) sensor, is used to determine a position of the image capture device 300. The accelerometer 344, such as a three-axis accelerometer, measures linear motion (e.g., linear acceleration) of the image capture device 300. The gyroscope 346, such as a three-axis gyroscope, measures rotational motion (e.g., rate of rotation) of the image capture device 300. Other types of movement sensors 340 may also be present or associated with the image capture device 300.

The power components 350 may receive, store, and/or provide power for operating the image capture device 300. The power components 350 may include a battery interface 352 and a battery 354. The battery interface 352 operatively couples to the battery 354, for example, with conductive contacts to transfer power from the battery 354 to the other electronic components of the image capture device 300. The power components 350 may also include an external interface 356, and the power components 350 may, via the external interface 356, receive power from an external source, such as a wall plug or external battery, for operating the image capture device 300 and/or charging the battery 354 of the image capture device 300. In some implementations, the external interface 356 may be the I/O interface 332. In such an implementation, the I/O interface 332 may enable the power components 350 to receive power from an external source over a wired data interface component (e.g., a USB type-C cable).

The user interface components 360 may allow the user to interact with the image capture device 300, for example, providing outputs to the user and receiving inputs from the user. The user interface components 360 may include visual output components 362 to visually communicate information and/or present captured images to the user. The visual output components 362 may include one or more lights 364 and/or more displays 366. The display(s) 366 may be configured as a touch screen that receives inputs from the user. The user interface components 360 may also include one or more speakers 368. The speaker(s) 368 can function as an audio output component that audibly communicates information and/or presents recorded audio to the user. The user interface components 360 may also include one or more physical input interfaces 370 that are physically manipulated by the user to provide input to the image capture device 300. The physical input interfaces 370 may, for example, be configured as buttons, toggles, or switches. The user interface components 360 may also be considered to include the microphone(s) 314, as indicated in dotted line, and the microphone(s) 314 may function to receive audio inputs from the user, such as voice commands.

In an example super-resolution model, LR image may be obtained by a down-sampling with kernel k on the HR and an additive noise. It can be written as follows:

(1) where k. and E is the noise. The development of the different parts of the degradation model is shown below.

For noise, a classical SISR model may consider E to be Gaussian, and independent between the pixels and between the images. However, this approach may not match the real noise distribution. For example, the noise on the RAW images may be approximate with a Poissonian distribution. Accordingly, the noise should be signal dependent. In camera outputs, the noise distribution may be transformed by the camera pipeline. If the pipeline is non-linear, it may be difficult to compute the resulting distribution. From this observation, it may not be desirable to work with a fixed distribution, rather determining an estimate of the noise distribution directly from the data would yield desirable results.

For the kernel, during the acquisition process, the image may be subject to different blurring sources. First, the image may be degraded by the shooting condition (i.e., camera-shake, exposition time, etc.). These degradations may be modeled using a blur kernel k_{blur}. The other blurring source may be the change of scale. The change of scale may be modeled using the

$$\frac{1}{s} .$$

intrinsic down-sampling kernel. This kernel will model the degradations introuuceu at scale

This kernel can be defined as follows:

$${\sum }_{m} {k}_{down} ( m ) {PSF}_{1} ( x - \frac{m}{s} ) = {PSF}_{\frac{1}{s}} ( x ) \qquad ( 2 )$$

That allows the transformation from the HR resolution to the LR resolution. We finally give to the model k=k_{blur} [symbol] k_{down}. The model may be adapted to spatially variant kernel degradations.

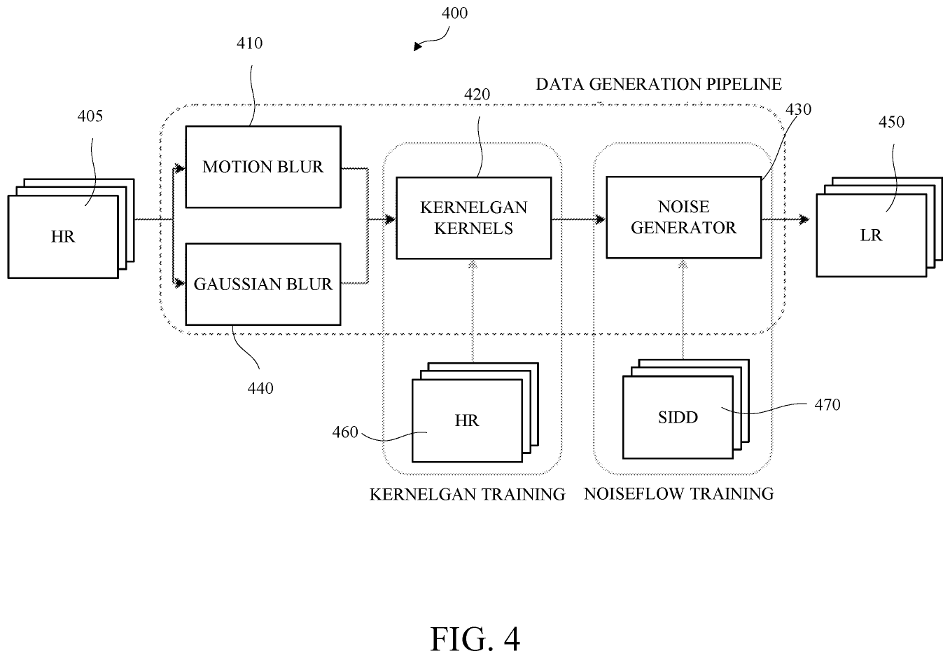

FIG. 4 is a block diagram of an example of a data generation pipeline 400. Most of the performance of a super-resolution model relies in the data. It is very difficult to gather low-resolution/high-resolution pairs, particularly in the multiple degradations framework. Synthetic data may be used to overcome this problem. The data generation pipeline 400 obtains HR images 405 and mimics real-world degradations using a camera-shake model for realistic motion blur 410, a GAN-based realistic down-sampling kernel generator 420, a noise generator 430 based on normalizing flows, or any combination thereof.

Regarding the blur kernel, instead of considering the blur kernel k_{blur} to be Gaussian, motion blur kernels may also be considered. Those blur kernels are obtained using a camera shake-model. In an example, 50% of the images may be degraded using Gaussian blur 440 and 50% may be degraded using motion blur 410. This model is also robust to spatially variant kernels.

Regarding the down-sampling kernel, a bicubic down-sampling kernel may be used in super-resolution. The bicubic down-sampling kernel is fast and can avoid aliasing, but does not correspond to the real world intrinsic down-sampling kernel. Training a model on bicubic down-sampling often leads to bad generalization properties on real world images. To over-come this issue, a modified version of KernelGAN may be used. The Gaussian constraints may be replaced from KernelGAN to a perceptual loss. The loss may be expressed as follows:

$$ℒ = - {E}_{z ∈ 𝒵} [ log ( D ( G ( z ) ) ) + {‖ Φ ( G ( z ) ) - Φ ( ( z ) {↓}_{s} ) ‖}_{1} ] + ‖ 1 - {\sum }_{i , j} {k}_{i , j} ‖ + {\sum }_{i , j} {‖ {k}_{i , j} ‖}^{0.5}$$

with Φ VGG-19 features extractor. The ∥Φ(G( [symbol] ))−Φ(( [symbol] ))75 ₛ)∥₁ will enforce the preservation of the elements in the image across the two scales while not relying on a down-sampling kernel that could bias the estimation. The two kernel constraints may enforce sparsity and the sum of the elements of the kernel is equal to one. Finally, the part with D(.) may ensure that the distribution between the generated LR 450 and the small patches match. This model may be trained on every image of the HR database 460 to obtain a pool of realistic down-sampling kernels [symbol] _{down}. The noise generator 430 may be trained using a Smartphone Image Denoising Dataset (SIDD) 460.

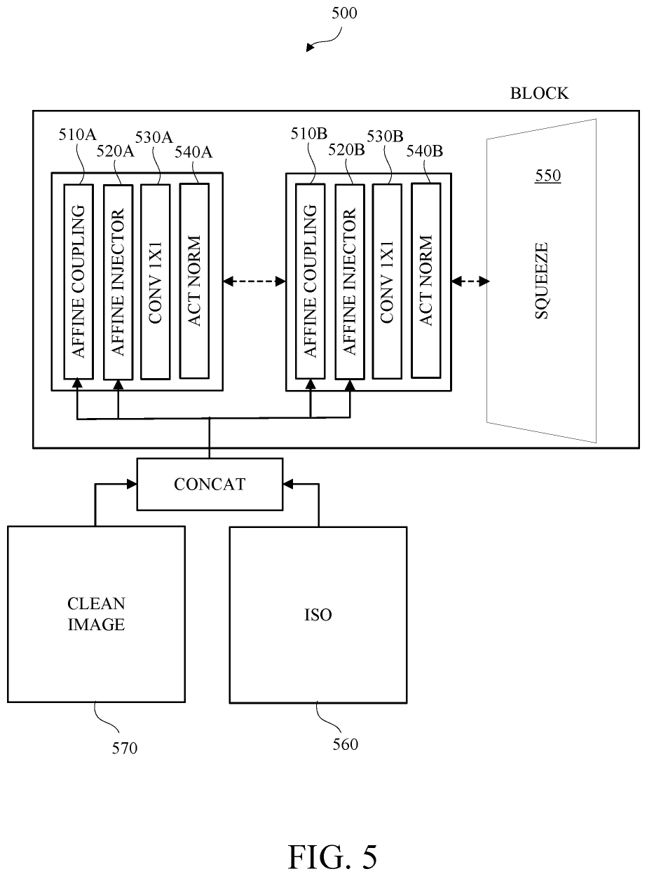

FIG. 5 is a block diagram of an example of a noiseflow block 500 that may be used for noise generation. The noise flow block 500 may be the noise generator 430 shown in FIG. 4. Instead of using a defined statistical model for the noise, the distribution from a dataset of noisy/clean pairs is learned. This approach has two advantages. First, once the model is trained to replicate a given noise from a given dataset, we can apply this given noise to every image we need. The given noise from a given dataset may correspond to a single camera since the noise distribution depends on camera parameters. The model is configured to recover, from a single realization of the noise per image, the full distribution of the noise. To learn such a distribution, a normalizing flow is implemented on the model. In an example, an invertible network is trained to encode the noise distribution into a latent space by minimizing the negative log-likelihood. A Gaussian prior can be used on the latent space.

As shown in FIG. 5, the noiseflow block 500 includes affine coupling layers 510A, 510B, affine injector layers 520A, 520B, convolutional layers 530A, 530B, activation normalization layers 540A, 540B, and a squeeze component 550. Given a noisy image y (e.g., ISO 560), its clean version x (e.g., clean image 570) and an invertible flow f_{θ} such that f_{θ}(y; x)=z, using the change of variable formula, the log-likelihood is defined as follows:

$$\begin{matrix}ℒ ( θ ; x , y ) = - log ( {p}_{y \vert x} ( y \vert x , θ ) ) \\ = - log ( {p}_{z} ( {f}_{θ} ( y ; x ) ) ) - log ( \vert det \frac{\partial {f}_{θ} ( y ; x )}{\partial y} \vert )\end{matrix}$$

Using the fact that f_{θ}(.) is the composition of N layers with hⁿ⁺¹=f_{θ}ⁿ (hⁿ; x) and h⁰=y, we have:

$$ℒ ( θ ; x , y ) = - log ( {p}_{z} ( {f}_{θ} ( y ; x ) ) ) - {\sum }_{i = 1}^{n} log ( \vert det \frac{\partial {f}_{θ}^{n} ( {h}^{n} ; x )}{\partial {h}^{n}} \vert ) \qquad ( 3 )$$

Working with layers, such as the affine coupling layers 510A, 510B, and affine injector layers 520A, 520B, that have a determinant that is fast and easy to compute may help to compute this loss efficiently. Once the network is trained, z from a Gaussian distribution may be sampled to obtain a noisy image \tilde{y} from its clean version with \tilde{y}=f_{θ}(z; x). In this example, the squeeze component 550 may be configured to perform upsampling.

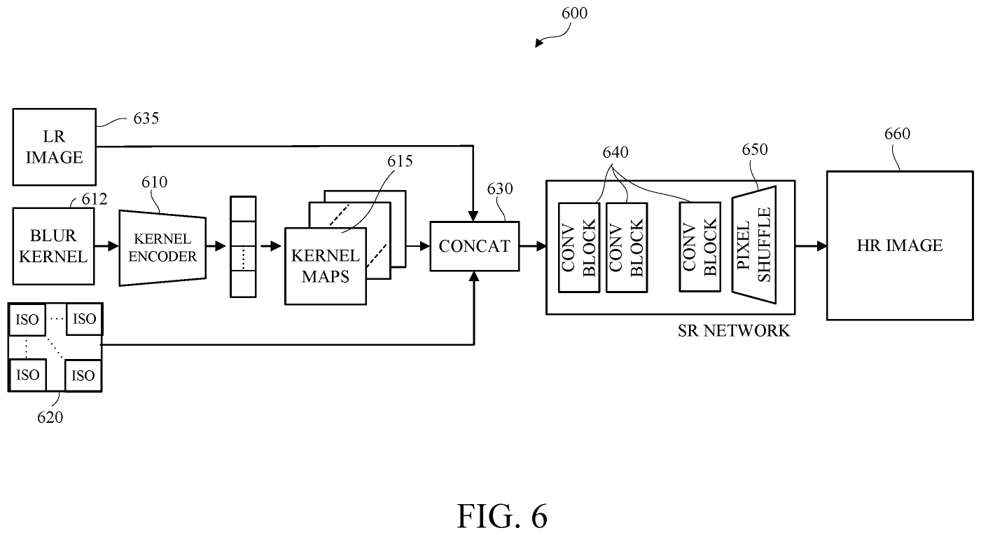

FIG. 6 is a block diagram of an example of a non-blind generator architecture 600 in accordance with embodiments of this disclosure. This super-resolution model example may use a non-blind estimation kernel or a blind estimation kernel. The non-blind architecture is composed of a kernel encoder 610 that that is configured to encode a kernel, such as a blur kernel 612 that has a kernel of size k_{size}*k_{size} to k_{features_size}. The encoded kernel is then reshaped to k_{features_size} constant maps 615. The noise level is also extended to a constant noise map 620. In this example, the ISO may be used, however the variance of the noise may also be used. The non-blind generator architecture 600 may include a concatenator 630 configured to concatenate those maps 615 to the LR images 635 and provide it to one or more convolutional blocks 640 followed by a pixel shuffle layer 650 to generate an HR image 660. The pixel shuffle layer 650 is configured to perform up-sampling to generate the HR image 660. In some examples, 9 convolutional blocks may be used.

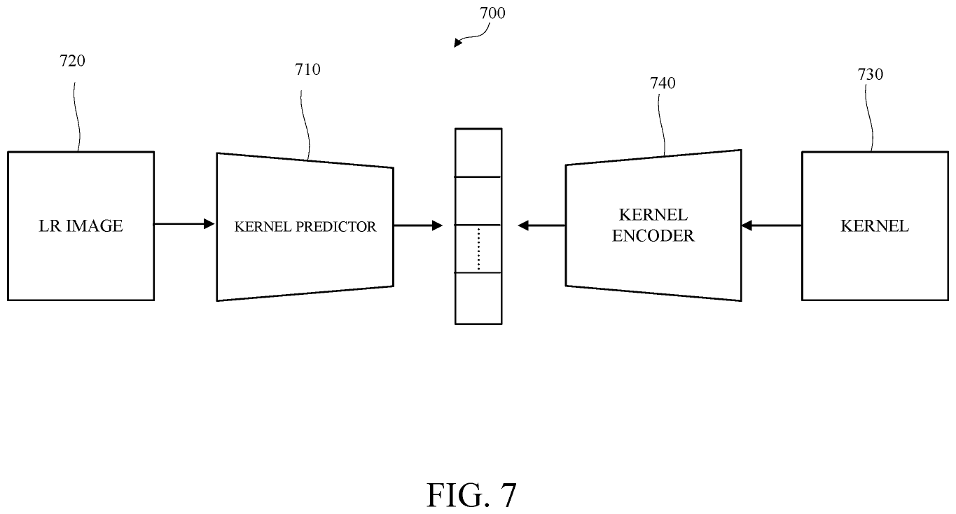

FIG. 7 is a block diagram of an example of a kernel prediction for a blind model 700 in accordance with embodiments of this disclosure. For the blind version of the model 700, a kernel predictor 710 that takes as input the LR image 720 and returns the estimated encoded blur kernel 730 of the image may be trained. The blur kernel of the image may be estimated in an iterative manner. The training of the kernel encoding predictor 710 may be performed after the training of the non-blind model when the kernel encoder 740 is trained.

Defined losses are used to train the model. The loss may be composed of three components, such as, for example, the pixel-wise L₁ loss, the perceptual L₁ loss based on VGG-19 features, and the relativistic average GAN (RaGAN) loss. The pixel-wise L₁ loss may be the stronger constraint. Since the data generation pipeline uses LR/HR pairs, the generated image may be directly compared to the HR image. This may force the network not to add artifacts or too many details. Accordingly, if f_{D} is set to be the distribution of the (LR, HR) pairs, the pixel-wise loss can be defined as follows:

[symbol]

_{pixel-wise}= [symbol] [∥*G(y)−x∥₁] (4)

The pixel-wise loss may be necessary to avoid artifacts, however it may not allow the network to add realistic details to the image. For the network to add realistic details to the image, a perceptual loss may be used. The perceptual loss may compare the features of the generated image and the HR image. The features that may be used are VGG-19 feature maps before activation. This constraint may enforce the network to preserve the elements on the image while allowing more freedom to the network to add details, textures. If Φ denotes the features extractor based on VGG-19 feature map, the perceptual loss can be written as:

[symbol]

_{perceptual}= [symbol] [∥Φ(G(y))−Φ(x)∥₁] (5)

Finally, the RaGAN loss may enforce the generator to produce realistic images. The discriminator may rate how realistic an image may appear and the generator may attempt to trick the discriminator. If fₓ denotes the distribution of the HR images and f_{y} distribution of the LR images, the RaGAN loss can be written as follows:

[symbol]

_{RaGAN}=−E_{x˜fx}[log(σ(C(x)−E_{y∈fy}[C(G(y))]))]

−E_{y∈fy}[log(1−σ(c(G(y))−E_{x˜fx}[σ(C(x))]))]

with σ the sigmoid function and C the result of the discriminator before activation. Finally, the loss for our generator may be defined as follows:

[symbol]

_{G}= [symbol] _{perceptual}+α [symbol] _{RaGAN}+β [symbol] _{pixel-wise} (6)

In the training, α=0:005 and β=0:01 may be used.

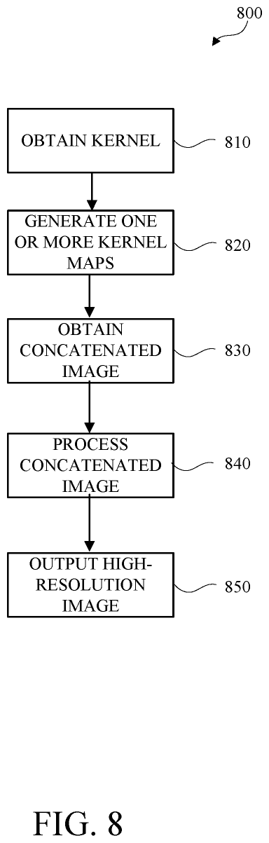

FIG. 8 is a flow diagram of an example of a method 800 for single image super-resolution (SISR) in accordance with embodiments of this disclosure. The method 800 includes obtaining 810 a kernel. Obtaining the kernel may include convolving a LR image with a filter, such as a Gaussian filter or a bicubic filter. The resulting image may be multiplied by a factor equal to s², where s is the scale factor. In some implementations, the kernel may be a blur kernel. The method 800 includes generating 820 one or more kernel maps. The one or more kernel maps may be based on one or more kernels, for example, the obtained kernel. The one or more kernel maps may include spatially variant kernel degradations. The method 800 includes obtaining 830 a concatenated image. The concatenated image may be based on a low-resolution image and the one or more kernel maps. The method 800 includes processing 840 the concatenated image using one or more convolutional layers of a super-resolution network to obtain a processed concatenated image. The method 800 includes outputting a high-resolution image. The high-resolution image is based on the processed concatenated image.

In some implementations, the method 800 may include reshaping an encoded kernel. Reshaping the encoded kernel can be based on the one or more kernel maps. The method 800 may include extending a noise level to a noise map. The noise map may be a constant noise map. The noise level may be associated with an ISO or a noise variance.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A non-blind generator, comprising:
a kernel encoder configured to obtain a kernel and generate one or more kernel maps;
a concatenator configured to concatenate a low-resolution image to one or more of the generated kernel maps to obtain a concatenated image; and
a super-resolution network configured to obtain the concatenated image from the concatenator, the super-resolution network comprising:
one or more convolutional layers configured to process the concatenated image; and
a pixel shuffle layer configured to output a high-resolution image based on the processed concatenated image.

2. The non-blind generator of claim 1, wherein the kernel is a blur kernel.

3. The non-blind generator of claim 1, wherein the kernel encoder is configured to reshape an encoded kernel.

4. The non-blind generator of claim 3, wherein the kernel encoder is configured to reshape the encoded kernel based on the one or more kernel maps.

5. The non-blind generator of claim 3, wherein a noise level is extended to a noise map.

6. The non-blind generator of claim 5, wherein the noise map is a constant noise map.

7. The non-blind generator of claim 5, wherein the noise level is associated with an ISO or a noise variance.

8. A method, comprising:
obtaining a kernel;
generating a kernel map based on the kernel, wherein the kernel map includes spatially variant kernel degradations;
obtaining a concatenated image based on a low-resolution image and the kernel map;
processing the concatenated image using one or more convolutional layers of a super-resolution network to obtain a processed concatenated image; and
outputting a high-resolution image based on the processed concatenated image.

9. The method of claim 8, wherein the kernel is a blur kernel.

10. The method of claim 8, further comprising:
reshaping an encoded kernel.

11. The method of claim 10, wherein reshaping the encoded kernel is based on the kernel map.

12. The method of claim 10, further comprising:
extending a noise level to a noise map.

13. The method of claim 12, wherein the noise map is a constant noise map.

14. The method of claim 12, wherein the noise level is associated with an ISO or a noise variance.

15. An image capture device, comprising:
an image sensor configured to obtain a low-resolution image;
a kernel encoder configured to obtain a kernel and generate a kernel map;
a processor configured to scale the low-resolution image to obtain a scaled image;
a concatenator configured to concatenate the scaled image to the kernel map to obtain a concatenated image; and
a super-resolution network configured to obtain the concatenated image from the concatenator, the super-resolution network comprising:
one or more convolutional layers configured to process the concatenated image; and
a pixel shuffle layer configured to output a high-resolution image based on the processed concatenated image.

16. The image capture device of claim 15, wherein the kernel encoder is configured to reshape an encoded kernel.

17. The image capture device of claim 16, wherein the kernel encoder is configured to reshape the encoded kernel based on the kernel map.

18. The image capture device of claim 16, wherein a noise level is extended to a noise map.

19. The image capture device of claim 18, wherein the noise map is a constant noise map.

20. The image capture device of claim 18, wherein the noise level is associated with an ISO or a noise variance.
